(19) United States
(12) Patent Application Publication
(10) Pub. No.: US 2014/0130396 A1
(43) Pub. Date: May 15, 2014

(54) REFLECTIVE DECOY

(71) Applicant: Ran Yaron, Boulder, CO (US)

(72) Inventor: Ran Yaron, Boulder, CO (US)

(21) Appl. No.: 13/681,146

(22) Filed: Nov. 19, 2012

Related U.S. Application Data
(60) Provisional application No. 61/632,639, filed on Jan. 27, 2012.

(51) Int. Cl. A01M 31/06; A01M 31/02; A01M 31/00

(52) U.S. Cl. CPC A01M 31/06; A01M 31/00; A01M 31/02
USPC 43/2; 248/475.1; 248/176.1

(57) ABSTRACT

A reflective decoy device for hunting wild turkey employs a glass mirror and strutted gobbler feathers. The turkey decoy device is attached to a hunting weapon, such as a shotgun or compound bow, with its mirror element substantially vertical to the line of fire. A partially transparent, partially reflective one-way mirror, half-silvered sight is incorporated in the mirror decoy for aiming the mirror perpendicular to the line of sight. This device create an illusion of a 3D decoy which may be used as a big game decoy for various animals such as antelope, mule deer, white tail, and elk.

### REFERENCE TO RELATED APPLICATIONS

This application claims priority of U.S. Provisional applications Ser. No. 61/632,639 filed on Jan. 27, 2012 entitled “Portable blind-decoy with one-way mirror sight for hunters”, and No. 61/687,774 filed on May 1, 2012 entitled “Portable blind-decoy for hunting wild turkeys”, the disclosures of which are incorporated fully herein by reference.

### BACKGROUND OF THE INVENTION

1. Field of the invention

This invention relates generally to the field of hunting decoys and more particularly to a reflective decoy device for safe stalking and luring of wild turkeys. The device is attached to a hunting weapon and reflects the image of the turkey back to itself as well as hiding the hunter.

2. Description of the Related Art

Native Americans have stalked wild turkeys throughout history. During turkey mating season, male turkeys (gobblers) may court female turkeys (hens). In a courting ritual, a gobbler will often spread out and raise his tail feathers (strut), blush his head to dark red and his neck to dark blue, then stretch them forward and gobble. Gobblers are often defensive of their mating territory, and they may confront and attack an intruding gobbler, particularly if the intruder is strutting and gobbling toward them or their hens. Hunters take advantage of that aggression to lure them in. A common technique is to set-up a decoy (see U.S. Pat. No. 7,784,213 to Primos) of a strutting gobbler, sit in a blind and wait. An alternative strategy is to locate the turkeys from a distance and stalk them. But, turkeys have extraordinary eyesight, which makes stalking difficult. To enhance successful stalking, hunters can hide behind hand-held strutted turkey tail feathers. This technique enables the hunter to get to about 70 yards from the turkey/s (not close enough for shooting which for a shotgun is under 40 yards and for a bow is under 20 yards). Then the hunter hides and sits still and hopes the gobbler will come closer. Another trick some hunters use is to crawl behind a full-body 3D turkey decoy and when the turkey sees it, to lie still and wait for the gobbler to come. Unfortunately, this method can result in having the hunter shot by another hunter.

Since the earliest attempts of hunting wild game, various forms of decoys and costumes have been used to help hunters stalk and lure animals. Hiding behind or inside a conventional decoy or an animal hide poses a risk to be mistakenly shot by another hunter.

It is therefore desirable to have a decoy sufficiently convincing to lure the animal without risking being shot by another hunter.

### SUMMARY OF THE INVENTION

The present invention is a reflective decoy device employing a mirror with turkey tail feathers around it. The mirror is attached to a weapon substantially perpendicular to the line of fire. The mirror element is adapted for reflecting back to the turkey its own image when aimed. A partially reflecting sighting aperture is incorporated in the mirror for the purpose of aiming the mirror to the turkey.

### BRIEF DESCRIPTION OF THE DRAWINGS

FIG. 1 is a perspective view of a first embodiment of the reflective decoy on shotgun;

FIG. 2 is an enlarged detailed perspective view of FIG. 1 showing attachment details for the reflective decoy;

FIG. 3 is a front view of the mirror element employed with the embodiments herein;

FIG. 4 is a side section view of the mirror along line 4-4 of FIG. 3 the sighting elements of the invention;

FIG. 5 is a pictorial representation of the overlay view as seen by the hunter in the sight;

FIG. 6 is a detail of the elements of the sighting aperture;

FIG. 7 is a perspective view of the reflective decoy on bow;

FIG. 8 is a perspective view of the bow and reflective decoy supported by a bipod;

FIG. 9 is a side view of the bow, reflective decoy and bipod of FIG. 8; and,

FIG. 10 is a detailed view of the bipod attachment.

### DETAILED DESCRIPTION

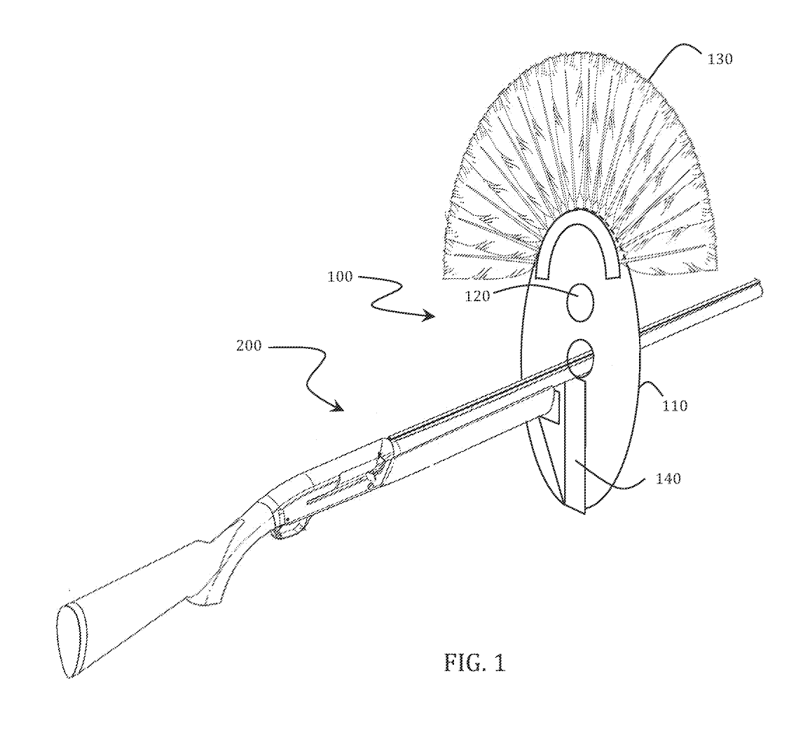

FIG. 1 provides an example of an embodiment of a reflective decoy 100 on a shotgun 200. While shown in the embodiment as a shotgun, alternative embodiments may employ a rifle or other hunting weapon. A glass mirror 110, large enough to hide the hunter's head and reflect the distinctive features of a turkey (head, neck and beard), as will be described in greater detail subsequently. The mirror 110 is equipped with a half silvered sighting aperture 120 and a fan of turkey tail feathers 130 is mounted on mirror which is in turn mounted on the shotgun 200 via bracket 140. While the embodiment described herein is adapted for hunting turkeys, the reflective decoy may be adorned with alternative supplemental elements and used to reflect the head of other game animals.

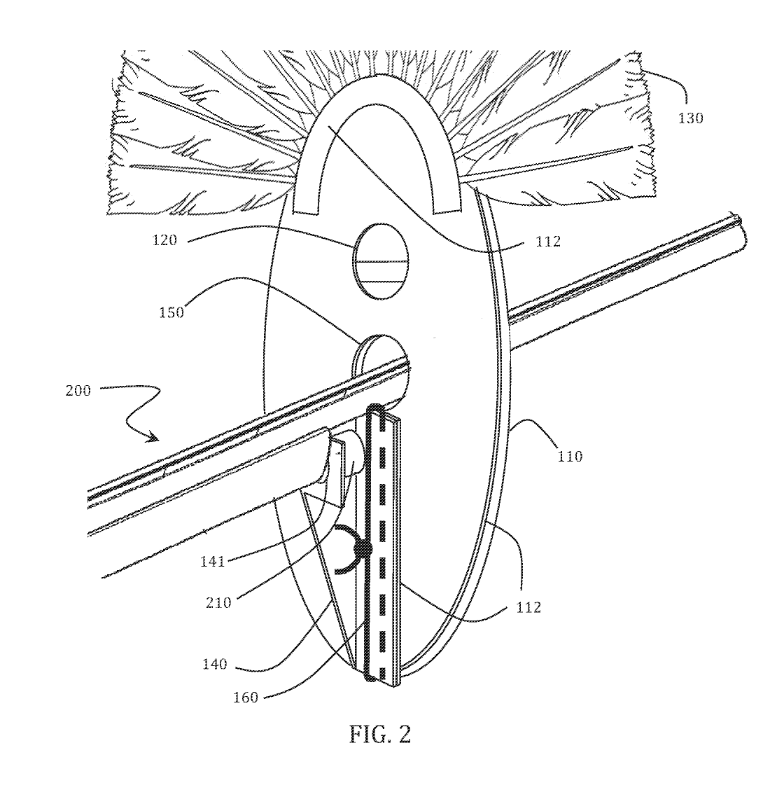

FIG. 2 provides a close up detail of the attachment elements of the glass mirror to the shotgun of FIG. 1. In this embodiment the bracket 140 is designed to fit the Remington MODEL 11-87 12-gauge shotgun. Bracket 140 is equipped with a 1⅛″ diameter attachment hole 141 where a magazine cap 210 of the shotgun 200 is used to secure the bracket 140 to the gun. The mirror 110 is attached to the bracket 140 by hook and loop fasteners 112. The feathers 130 may also be attached to the mirror with hook and loop fasteners 112. The mirror 110 is substantially elliptic having minor and major axes of 9×16″ (230×400 mm) and is made from ¼″ (˜6 mm) mirror glass. A 2″ hole 150 in the mirror 110 is made for the barrel of the shotgun and a sighting aperture 120, to be described in greater detail subsequently, is present. Rubber band 160 is employed for supplemental attachment of the mirror 120 and bracket 140 for shock absorption.

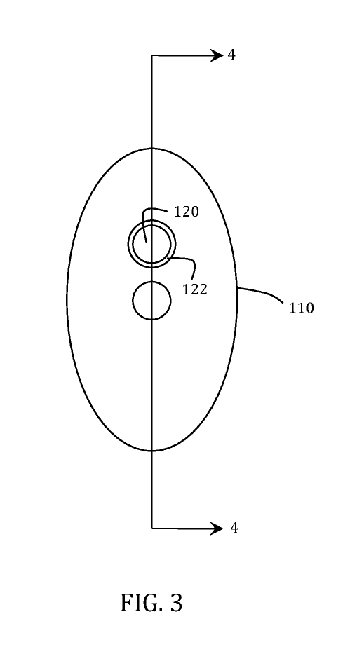

FIG. 3 shows a front view of the mirror 110 with the sighting aperture 120 and a partially silvered sighting element 122. For an animal to see himself reflected in the glass mirror 110, the mirror must be orthogonal to a line of sight between the hunter and the animal. This is not easily accomplished by merely pointing the weapon at the animal, particularly at longer ranges. The present embodiments therefore incorporate a dual reflective sighting system. In the glass mirror 110, the coating is removed (not the glass) to expose the glass and form an optical window as the sighting aperture 120.

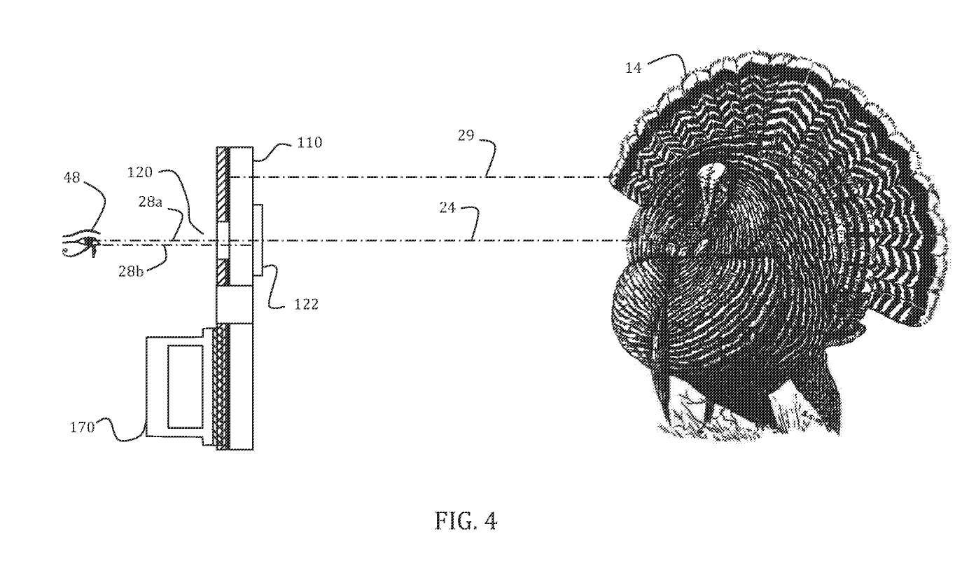

FIG. 4 shows a one-way mirror (partially reflective, partially transparent) is formed by, for example using a reflective film 122 such as “Gila MIRROR PR5361” bonded to the sighting aperture 120 with reflective action between the hunter and the glass mirror (thicknesses in FIG. 4 are exaggerated for clarity). Alternatively, the glass mirror 110 may be partially silvered in the region of the sighting aperture 120 to create a one way reflective element as is known in the art. When aligned using a handle 170 (or the bracket 140 when attached to the shotgun 200 as shown in FIGS. 1 and 2), the hunter can see both, the animal or any desired target (partially transparent) and the reflection (partially reflective) of his own eye 48. By aligning the eye with the partially reflective aperture as represented by ray 28a an image of the eye then reflects back to the observer's eye 48 as ray 28b and the target or animal 14, aligned as represented by the ray of a line of sight 24, is also visible in the aperture. When the first mirror element is brought to an orthogonal orientation with the animal by aligning the eye and animal images, the animal can see itself reflected in a first direction from the glass mirror 110 as represented by ray 29. For the example embodiment with a turkey, seeing its own reflection, complete with movement of head, ears, eyes, neck and beard, the turkey interprets the mirror element (and the hunter behind) as a second animal of his own species and, therefore, as non-threatening or during mating season as a challenger.

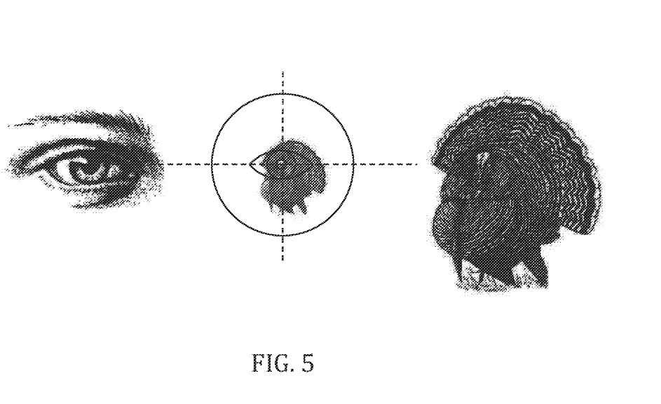

FIG. 5 shows the self-reflected aiming eye of the hunter on the targeted turkey.

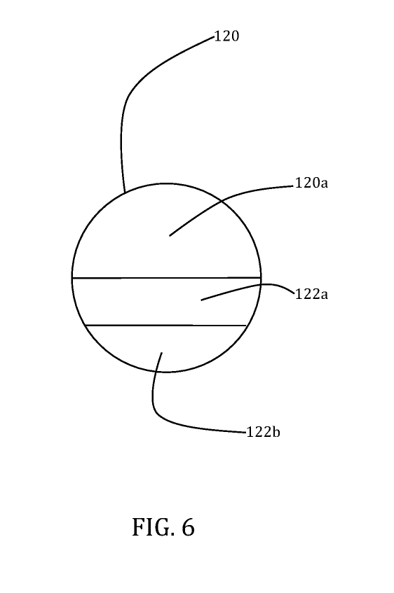

FIG. 6 shows a sighting element 120 incorporating a top portion of the sighting aperture designated 120a which is unsilvered providing a clear unobstructed view for sighting a weapon such as a bow with the integral bow sights. A second intermediate portion of the sighting aperture is partially silvered for partial reflectance and partial transparence. This may be accomplished in example embodiments using one layer of reflective film 122a to provide approximately 50% transmission and 50% reflection. A lower portion of the sighting aperture is additionally silvered for greater reflectance to accommodate conditions where the animal may be in direct sunlight but the hunter may be in shade therefore requiring additional reflection from the mirror to see his eye. This may be accomplished in example embodiments by using a second layer of the reflective film 122b to provide approximately 25% transmission and 75% reflection.

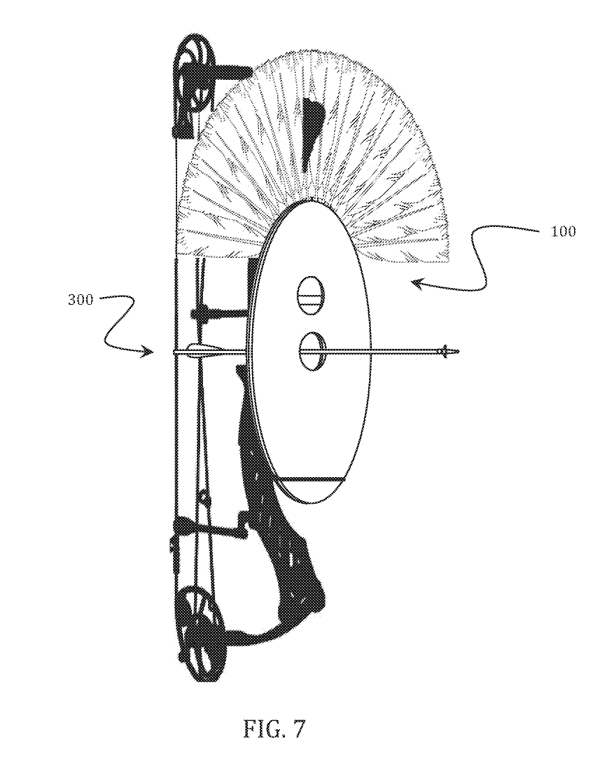

FIG. 7 shows the reflective decoy 100 attached to a compound bow 300.

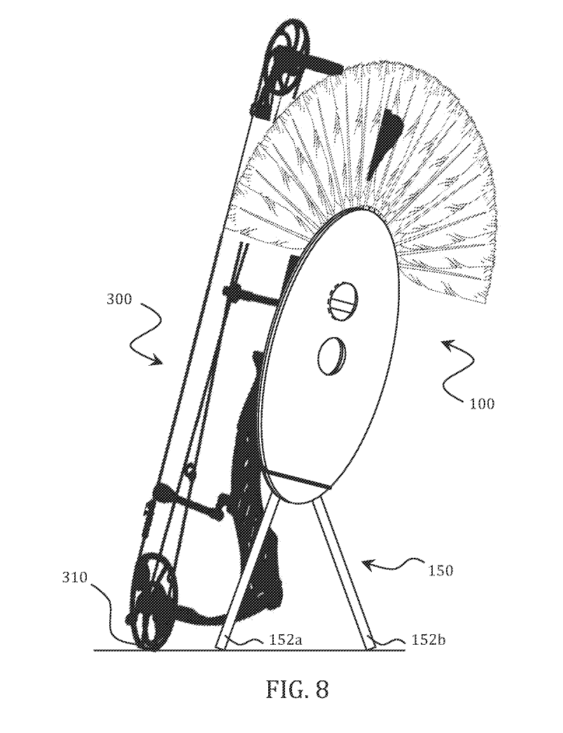

FIG. 8 shows a bipod 150 having two legs 152a and 152b may also be added to the bow 300 in conjunction with the mounting of the reflective decoy 100. The bipod allows the bow to be placed upright on the ground against the bow's cam 310. By freeing his arms, the hunter can use box and/or slate calls to help lure the gobbler into the mirror's effective range.

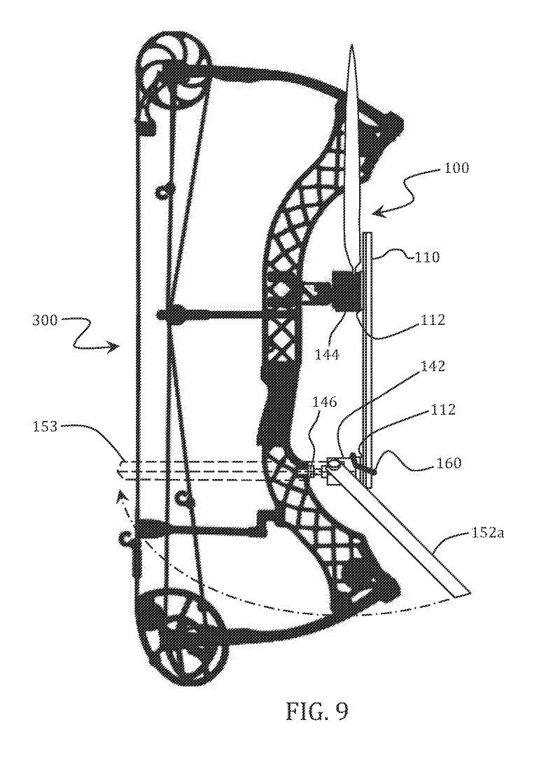

FIG. 9 shows hook and loop fasteners 112 attach the glass mirror 110 of the reflective decoy 100 to the bow 300 via a bracket 142, comparable in function to the bracket 140 (see FIGS. 1 and 2) employed with the shotgun. The bow's frontal standard 5/16-24 threaded hole 146 is used to connect the bracket 142 which is made of 5/16-24 threaded steel rod and aluminum plate, as will be described in greater detail subsequently, covered with a hook and loop fastener 112. Another hook and loop fastener 112 is bonded to the front of the bow's sight 144 to provide the second attachment, preventing the glass mirror 110 from swinging. Rubber band 160 provides additional security and shock absorption. The bipod legs 152a (and 152b which is hidden in this view) are attached to the supporting bracket 142 in a manner allowing the legs to swivel to a horizontal position as represented by phantom leg 153.

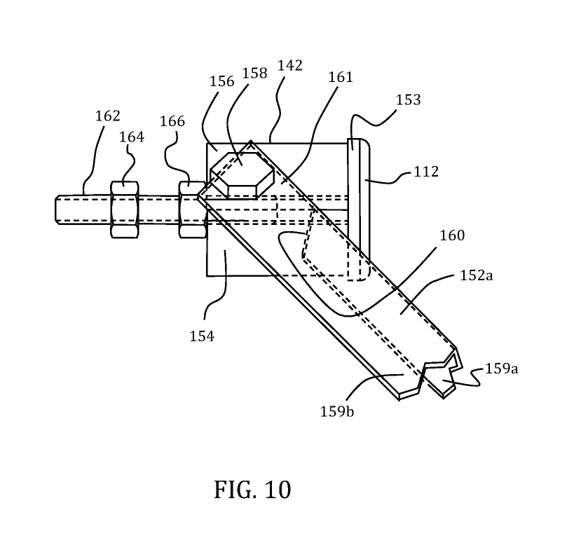

FIG. 10 shows a close-up view of the bracket 142 with its bipod leg 152a. The bracket 142 includes a flat plate 153 and substantially square aluminum block 154 with edges oriented horizontally and vertically providing flats 156 angled at 45 degrees. Threaded bores in the flats receive bolts 158 which attach the legs (152a shown) to the bracket. Each bipod leg may be fabricated from, for example, an aluminum L beam or angle with a first surface 159a cut to create a relief 160 leaving a flat tab 161 on a second surface 159b with a hole through which the bolt 158 is inserted. The unrelieved portion of the first surface 159a engages a lower flat of the block 154 to limit forward travel of the bipod leg. Reward rotation about the bolt 158 allows the leg 152a to be rotated to the horizontal position (shown as 153 in FIG. 9) and described above. Attachment of the bracket to the bow frontal standard hole (element 146 in FIG. 9) is accomplished with a threaded rod 162 extending from the block 154 with appropriate jam nuts 164 and 166 for adjustment of the overall length of the bracket. As previously described, a hook and loop fastener 112 is adhered to a front surface of the flat plate 153 for engaging the glass mirror.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An alignment device for a reflecting decoy comprising:
a substantially flat mirror reflecting in a first direction and having an aperture, at least a first portion of the aperture having a partially transparent and partially reflective coating for reflection in a second direction;
a support for the mirror to suspend the aperture before an eye of a hunter located in the second direction with respect to the mirror wherein by viewing an animal positioned in said first direction and overlaying a reflection of the eye in the second direction the mirror element is orthogonal to a line of sight from the animal to the flat mirror element.

2. The alignment device as defined in claim 1 wherein the partially reflective coating has a first value of reflectance in a first portion of the sighting aperture and a second value of reflectance in a second portion of the sighting aperture.

3. The alignment device as defined in claim 1 further comprising an attachment aperture for affixing the mirror to the hunting weapon.

4. The alignment device as defined in claim 3 wherein the hunting weapon is a shotgun.

5. The alignment device as defined in claim 3 wherein the hunting weapon is a compound bow.

6. The alignment device as defined in claim 3 wherein the partially reflecting sighting aperture comprises an unsilvered portion of the mirror having a partially transparent and partially reflective coating, a reflective direction of said coating receiving and reflecting an eye image of the hunter, wherein said orthogonal angle is established by alignment of the reflected eye image and the image of the animal.

7. The alignment device as defined in claim 3 wherein the partially reflective coating has a first value of reflectance in a first portion of the sighting aperture and a second value of reflectance in a second portion of the sighting aperture.

8. The alignment device as defined in claim 3 wherein the sighting aperture includes a non-reflective portion for sighting of the hunting weapon.

9. A reflecting decoy device comprising:
a mirror attached to a hunting weapon substantially orthogonal to a line of fire and adapted for reflecting an image of an animal back to itself at an orthogonal angle with the line of sight parallel to the line of fire and having a partially reflecting sighting aperture in an unsilvered portion of the mirror element with a partially transparent and partially reflective coating, a reflective direction of said coating receiving and reflecting an eye image of the hunter, wherein said orthogonal angle is established by alignment of the reflected eye image and the image of the animal, the partially reflective coating has a first value of reflectance in a first portion of the sighting aperture and a second value of reflectance in a second portion of the sighting aperture; and,
strutted turkey tail feathers removably mounted to the mirror element extending from a periphery of the mirror element sufficient for masking at least a hunter's torso and head.

10. The reflective decoy device of claim 9 wherein further comprising a bracket, said mirror attached to said bracket with a hook and loop fastener and said strutted turkey tail feathers attached to the mirror assembly with hook and loop fastener elements.

11. The reflecting decoy device of claim 10 wherein the bracket is attached to a bow with a support rod received in a threaded bore.

12. The reflecting decoy device of claim 10 wherein the bracket incorporates legs rotatable from a horizontal position to an extended position, said legs forming a tripod with a lower limb of the bow.

13. A method for aligning a reflective device comprising:
viewing with an eye a target through a partially reflective sighting aperture in a substantially flat mirror;
aligning a reflection of the eye in the sighting aperture with the target thereby establishing an orthogonal orientation of the mirror with respect to a line of sight between the eye and the target.

14. The method of claim 13 wherein the target is a wild turkey.

15. A support for maintaining a bow in a vertical position comprising:
a bracket extending from a frontal standard threaded hole in a bow;
two legs rotatably attached to the bracket and positionable in a first retracted horizontal position and a second extended position forming a tripod with a lower limb of the bow.

16. The support of claim 15 wherein the bracket incorporates a block having upper flats oriented 45 degrees from vertical and each leg includes a tab rotatably attached to a flat, said leg having a relieved portion forming the tab, a periphery of the relieved portion contacting a lower flat of the block as a stop in a rotated position.
